(19) United States
(12) Patent Application Publication
(10) Pub. No.: US 2024/0217075 A1
(43) Pub. Date: Jul. 4, 2024

(54) Telescopic socket tools

(71) Applicant: Joaquin L. Palau, Brandon, FL (US)

(72) Inventor: Joaquin L. Palau, Brandon, FL (US)

(21) Appl. No.: 17/300,232

(22) Filed: Apr. 20, 2021

(51) Int. Cl. B25B 23/00; B25B 13/06

(52) U.S. Cl. CPC B25B 23/0021; B25B 13/06; B25B 23/0035

(57) ABSTRACT

A telescopic socket tool extender that is used to tighten or loosen nuts that are way above one's head. The telescopic socket extender comprises of a first, second and third rod that are telescopically connected. The first rod having a greater diameter than the second rod, and the second rod having a greater diameter than the third rod. The first rod is connected to a square socket insert that allows it to be connected to a drill via a bit. The third rod attaches to a socket mount that defines a socket.

### BACKGROUND

The present invention is directed to a telescopic tool that is placed on a drill, the telescopic tool is used to fix electrical, plumbing, and air conditioning support systems,

The telescopic tool has been designed for fixing support systems in electrical, plumbing and air conditioning industrial works, by adjusting and lifting nuts of different sizes, depending on the case. For example: for electricity 7/16″ nuts, for air conditioning ductwork 9/16″ nuts and for plumbing 9/16″ and ¾″ nuts.

These nuts are moved upwards by this tool, through all thread rods that are served by suppliers to installer's customers in 5′ length format, which are fixed to ceilings or other elements and joined together with perforated Unistrut, serve as support for all the piping and ductwork used in these specialties. This is the reason why the telescopic design has been thought to satisfy the needs according to the heights.

Examples of installations according to specialty: fixing of plumbing pipes, see FIG. 1; fixing of air conditioning ducts, see FIG. 2; and fixing of pipes for electricity cables, see FIG. 3.

The conception of this tool is the improvement of existing tools, which solve this need, but are shown and sold in the market as fixed dimensions.

In one of the cases, the MAKITA tools solve this need, but they are limited both to the size and dimensions of the socket, related to the dimensions of the nut to be fixed, which means that there are tools with socket sizes 9/16″ and ¾″ with lengths of 30.5 cm, 46 cm, 61 cm each, not existing for the socket size 7/16″, as far as I have seen.

That is why we say 9 in 1, because 3 sockets with 3 different lengths are related. The tool works as a socket wrench, supported by three tubular pieces coupled together, one inside the other, whose tubular shaft shape, allows the rotation at 360° and by means of external protrusions in the form of cams, allows the dragging of each one to achieve the torque of the tool.

Also, there are other options of manufactured preparation that operators usually manufacture, due to the non-existence of this type of tool in previous years of the release of MAKITA tools or other brands.

### SUMMARY

The present invention is a telescopic socket tool extender that comprises of three tubular elements that fit together and are inserted into each other:

The first tubular element consists of the support sleeve, the tubular element T1 and fixing screws.

This tubular element T1 has two threaded holes where the M5×8 cylindrical screws with embedded hexagonal head will be housed and also, this same element has at the opposite end to these holes, two holes where the pins of element T2 will be housed or inserted, to stop the forward displacement of this element T2, these holes are located at a distance of approximately 3″, leaving part of the element T2, inside the element T1, to avoid bending and sudden movements at the time of work.

The second tubular element T2, has 2 pins coupled through 2 M3×4 cylindrical Philips flat head screws, on the other hand, this same element has at the opposite end of the pins, two holes where the pins of the element T3 will be placed or inserted, to stop the forward displacement of this element T3, these holes are located at a distance of approximately 3″, leaving part of the element T3, inside the element T2, to avoid bending and sudden movements at the time of work. In addition, this element T2 has two external protruding protuberances of the maximum diameter, which will serve as a stop in the return movement and to grip this element T2, leaving it fixed, when you want to move the tubular element T3 forward.

The third tubular element T3 has two holes at one end, through which the sockets are attached by means of two M5×8 cylindrical hexagonal head socket head cap screws. On the other hand, this same element has at the opposite end, two holes for the location of the flexible pins and two holes for fixing them by means of two M3×4 cylindrical Philips flat head screws.

A second section, where the tubular element T2 is moved forward, through the protruding stops, so that the element T1 does not come out at the same time forward, until the holes of the element T2 coincide with the pins of the element T3 and it is fixed, being able to move the nuts from lengths of 2′ 7″, or, that the element T2 is retained or immobilized through these protrusions to pull the element T1 forward, until the holes of the element T1 coincide with the pins of the element T2 and it is fixed, being able to move the nuts from lengths of 2′ 7″.

The third section is shown when, once element T2 is deployed, element T3 is also deployed, until the pins of element T3 are fixed in the holes of element T1, or vice versa as in the previous case, being able to move the nuts from lengths of 3′ 4½″.

In summary, the tool allows the displacement of 7/16″, 9/16″ and ¾″ nuts, from small distances up to almost the entire length of the threaded rod, being able to work even from the ground.

As it can be made of hard plastics, anodized aluminum or other rigid materials that allow its stability, it gives us the possibility to give it the corporate colors of the established brands in the market.

An object of the present invention is to provide a telescopic socket tool extender that will allow a user to tighten or release nuts or bolts that are secured above him or her.

Another object of the present invention is to provide a telescopic socket tool extender that will allow a user to use custom sockets that can be used in plumbing electrical, and air conditioning installations.

Yet another object of the present invention is to provide a telescopic socket tool extender that is lightweight.

Still another object of the present invention is to provide a telescopic socket tool extender that can provide a high degree of torque to a socket that is not near the drill that provides the torque.

Yet still another object of the present invention is to provide a telescopic socket tool extender that will allow the a use of a ⅜″×⅜″ square socket in the support sleeve of the present invention, for coupling the tool with a ⅜″ socket adapter.

### DRAWINGS

These and other features, aspects, and advantages of the present invention will become better understood with regards to the following description, appended claims, and drawings where:

FIG. 1 is a picture that shows a system of plumbing pipes wherein the present invention would be used;

FIG. 2 is a picture that shows air conditioning ducts wherein the present invention would be used;

FIG. 3 is a picture that shows pipes of electrical cables wherein the present invention would be used;

FIG. 4 is a perspective view of the present invention is an extended position, wherein all three rods are extended;

FIG. 5 is a perspective view of the present invention in a second extended position, wherein only two rods are extended;

FIG. 6, is a perspective view of the present invention in a first extended position, wherein the second and third rods of the present invention are retracted within the first rod;

FIG. 7 is a perspective view of a bit that would be used to connect the present invention to a drill;

FIG. 8 is a perspective view of a socket mount and socket of the present invention;

FIG. 9 is a perspective view of another embodiment of the socket mount and socket of the present invention;

FIG. 10 is a perspective view of yet another embodiment of the socket mount and socket of the present invention;

FIG. 11 is an exploded view of the first rod and the square socket insert of the present invention;

FIG. 12 is a perspective view of the first rod and the square socket insert of the present invention;

FIG. 13 is an exploded view of the second rod of the present invention;

FIG. 14 is a perspective view of the second rod of the present invention;

FIG. 15 is an exploded view of the third rod of the present invention; and

FIG. 16 is a perspective view of the third rod of the present invention.

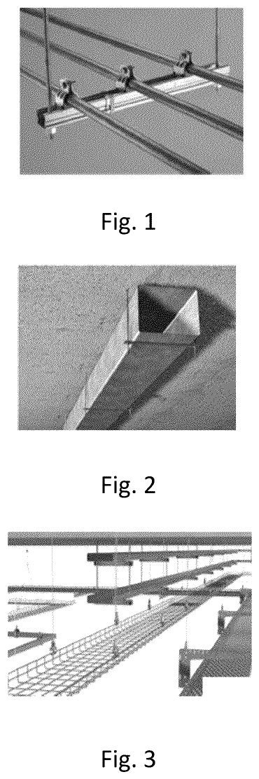

### DESCRIPTION

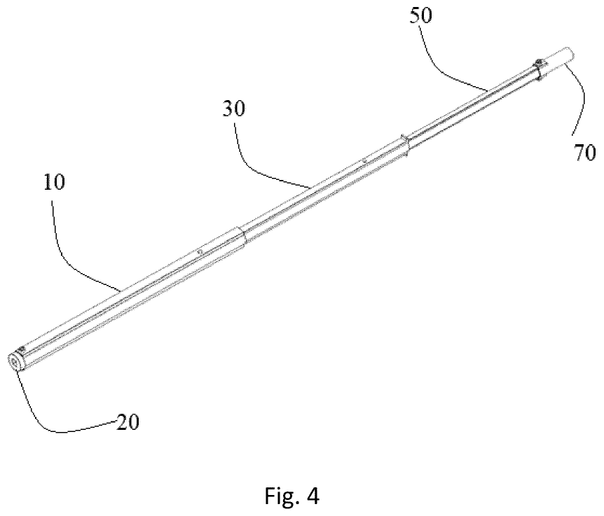

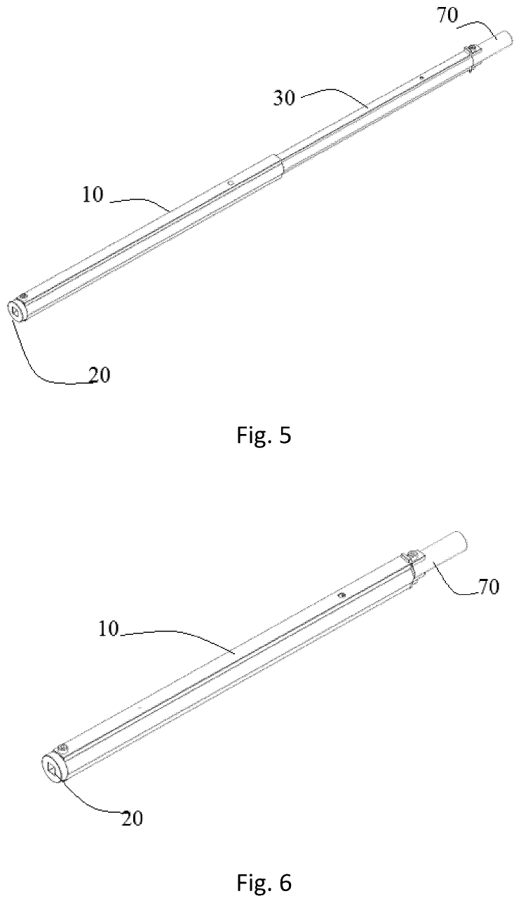

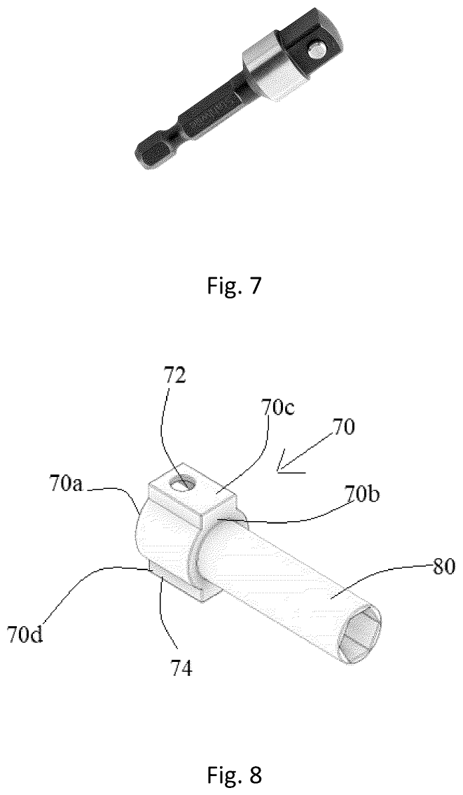

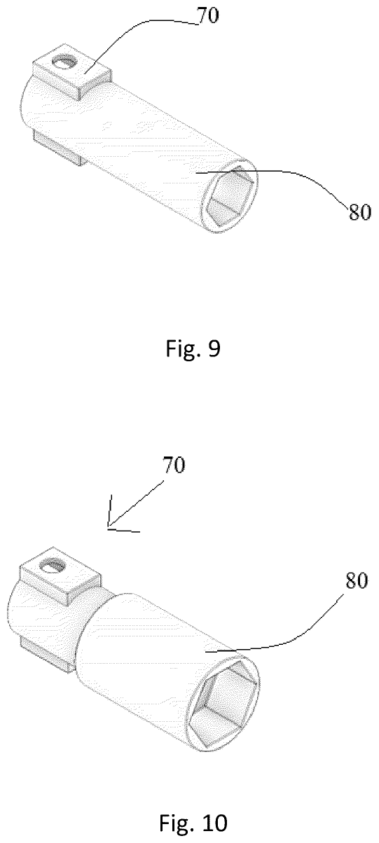

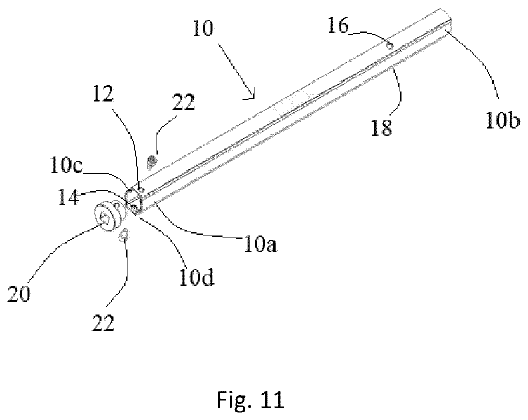

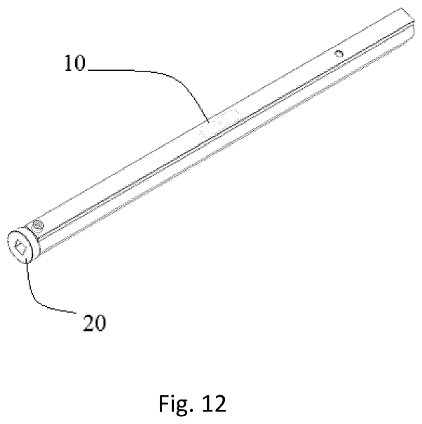

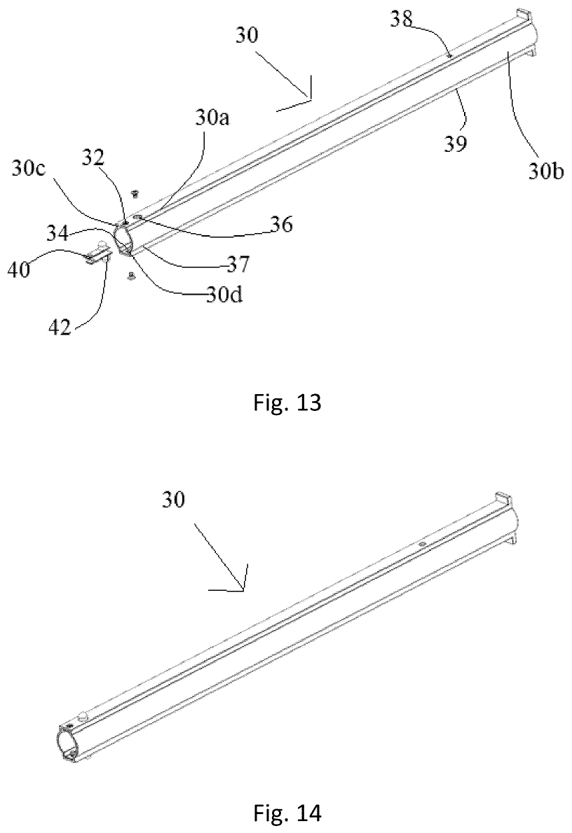

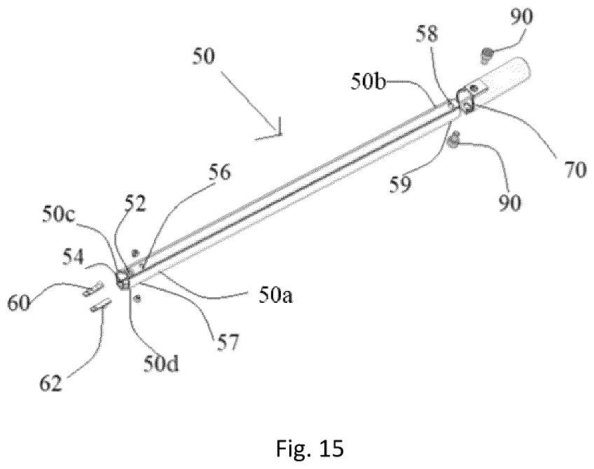

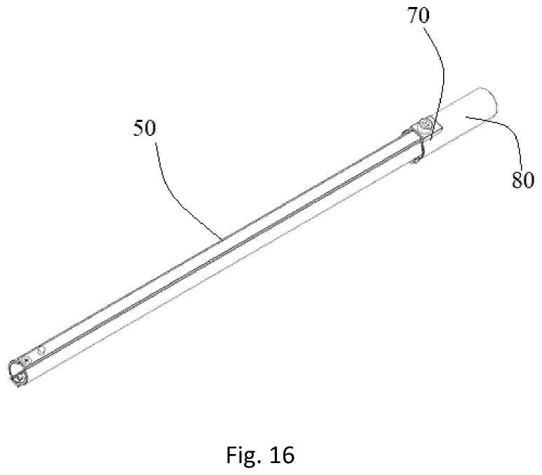

As seen in FIGS. 3-16, the present invention is a telescopic socket tool extender 100. The telescopic socket extender 100 comprises a first rod 10 having a first end 10a and a second end 10b, the first rod 10 being hollow, an upper part 10c of the first rod 10 being u-shaped and a lower part 10d of the first rod 10 being u-shaped, the first end 10a of the first rod 10 defines a first aperture 12 on the upper part 10c of the first rod 10 and a second aperture 14 on the lower part 10d of the first rod 10, the first aperture 12 and second aperture 14 are linearly aligned to each other, the second end 10b of the first rod 10 defines a third aperture 16 on the upper part 10c of the first rod 10 and a fourth aperture 18 on a lower part 10d of the first rod 10, the third aperture 16 and the fourth aperture 18 are aligned to each other and are a distance of at least three inches from the second end 10b. A square socket 20 inserts within the first end 10a of the first rod 10, the square socket 20 is secured on the first rod 10 by a pair of screws 22 that screw into the first aperture 12 and the second aperture 14 of the first rod 10, the square socket 20 is configured to receive a square bit that is attached to a drill. A second rod 30 having a first end 30a and a second end 30b, the second rod 30 being hollow, an upper part 30c of the second rod 30 being u-shaped and a lower part 30d of the second rod 30 being u-shaped, the second rod 30 having a diameter that allows the second rod 30 to insert within the first rod 10, the first end 30a of the second rod 30 defines a first aperture 32 on the upper part 30c of the second rod 30 and a second aperture 34 on the lower part 30d of the second rod 30, the first aperture 32 and second aperture 34 are linearly aligned to each other, an upper pin aperture 36 is defined on the upper part 30c of the second rod 30 and a lower pin aperture 37 is defined at lower part 30d of the second rod 30, the upper pin aperture 36 is adjacent to the first aperture 32 of the second rod 30, the lower pin aperture 37 is adjacent to the second aperture 34 of the second rod 30, an upper pin 40 is secured to the upper part 30c of the first end 30a of the second rod 30, and a lower pin 42 is secured to the lower part 30d first end 30a of the second rod 30, the upper pin 40 is placed within the upper pin aperture 32 and the lower pin 42 is placed within the lower pin aperture 34, the second end 30b of the second rod 30 defines a third aperture 38 on the upper part 30c of the second rod 30 and a fourth aperture 39 on a lower part 30d of the second rod 30, the third aperture 38 and the fourth aperture 39 are aligned to each other and are a distance of at least three inches from the second end 30b of the second rod 30, the second rod 30 is inserted within the first rod 10. A third rod 50 having a first end 50a and a second end 50b, the third rod 50 being hollow, an upper part 50c of the third rod 50 being u-shaped and a lower part 50d of the third rod 50 being u-shaped, the third rod 50 having a diameter that allows the third rod 50 to insert within the second rod 30, the first end 50a of the third rod 50 defines a first aperture 52 on the upper part 50c of the third rod 50 and a second aperture 54 on the lower part 50d of the third rod 50, the first rod aperture 52 and second rod aperture 54 are linearly aligned to each other, an upper pin aperture 56 is defined on the upper part 50c of the third rod 50 and a lower pin aperture 57 is defined at lower part 50d of the third rod 50, the upper pin aperture 56 is adjacent to the first aperture 52 of the third rod 50, the lower pin aperture 57 is adjacent to the second aperture 54 of the third rod 50, an upper third rod pin 60 is secured to the upper part 50c of the first end 50a of the third rod 50, and a lower third rod pin 62 is secured to the lower part 50d first end 50a of the third rod 50, the upper third rod pin 60 is placed within the upper pin aperture 56 and the lower third rod pin 62 is placed within the lower pin aperture 57, the second end 50b of the third rod 50 defines a third aperture 58 on the upper part 50c of the third rod 50 and a fourth aperture 59 on a lower part 50d of the third rod 50, the third aperture 58 and the fourth aperture 59 are aligned to each other and adjacent to the second end 50b of the third rod 50, the third rod 50 is inserted within the second rod 30. And, a socket mount 70 that has a first end 70a and second end 70b, the first end 70a is hollow and has the same shape as the third rod 30, yet the socket mount 70 has a greater diameter than the third rod 50, the second end 70b defines a socket 80, the first end 70a of the socket mount 70 defines a first socket aperture 72 on an upper part 70c of the socket mount 70 and a second socket aperture 74 on a lower part 70d of the socket mount 70, the socket mount 70 is mounted on the second end 50b of the third rod 50 and is configured to be secured to the third rod 50 by a pair of socket securing screws 90.

An advantage of the present invention is that it provides a telescopic socket tool extender that allows a user to tighten or release nuts or bolts that are secured above him or her.

Another advantage of the present invention is that it provides a telescopic socket tool extender that allows a user to use custom sockets that can be used in plumbing electrical, and air conditioning installations.

Yet another advantage of the present invention is that it provides a telescopic socket tool extender that is lightweight.

Still another advantage of the present invention is that it provides a telescopic socket tool extender that provides a high degree of torque to a socket that is not near the drill that provides the torque.

Yet still another advantage of the present invention is that it provides a telescopic socket tool extender that allows the use of a ⅜″×⅜″ square socket in the support sleeve of the present invention, for coupling the tool with a ⅜″ socket adapter.

While the inventor's above description contains many specificities, these should not be construed as limitations on the scope, but rather as an exemplification of several preferred embodiments thereof. Many other variations are possible. Accordingly, the scope should be determined not by the embodiments illustrated, but by the specification, the drawings, and the appended claims and their legal equivalents.

What is claimed is:

1. A telescopic socket tool extender, the telescopic socket extender comprises:
a first rod having a first end and a second end, the first rod being hollow, an upper part of the first rod being u-shaped and a lower part of the first rod being u-shaped, the first end of the first rod defines a first aperture on the upper part of the first rod and a second aperture on the lower part of the first rod, the first aperture and second aperture are linearly aligned to each other, the second end of the first rod defines a third aperture on the upper part of the first rod and a fourth aperture on a lower part of the first rod, the third aperture and the fourth aperture are aligned to each other and are a distance of at least three inches from the second end;
a square socket inserts within the first end of the first rod, the square socket is secured on the first rod by a pair of screws that screw into the first aperture and the second aperture of the first rod, the square socket is configured to receive a square bit that is attached to a drill;
a second rod having a first end and a second end, the second rod being hollow, an upper part of the second rod being u-shaped and a lower part of the second rod being u-shaped, the second rod having a diameter that allows the second rod to insert within the first rod, the first end of the second rod defines a first aperture on the upper part of the second rod and a second aperture on the lower part of the second rod, the first aperture and second aperture are linearly aligned to each other, an upper pin aperture is defined on the upper part of the second rod and a lower pin aperture is defined at lower part of the second rod, the upper pin aperture is adjacent to the first aperture of the second rod, the lower pin aperture is adjacent to the second aperture of the second rod, an upper pin is secured to the upper part of the first end of the second rod, and a lower pin is secured to the lower part first end of the second rod, the upper pin is placed within the upper pin aperture and the lower pin is placed within the lower pin aperture, the second end of the second rod defines a third aperture on the upper part of the second rod and a fourth aperture on a lower part of the second rod, the third aperture and the fourth aperture are aligned to each other and are a distance of at least three inches from the second end of the second rod, the second rod is inserted within the first rod;
a third rod having a first end and a second end, the third rod being hollow, an upper part of the third rod being u-shaped and a lower part of the third rod being u-shaped, the third rod having a diameter that allows the third rod to insert within the second rod, the first end of the third rod defines a first aperture on the upper part of the third rod and a second aperture on the lower part of the third rod, the first aperture and second aperture are linearly aligned to each other, an upper pin aperture is defined on the upper part of the third rod and a lower pin aperture is defined at lower part of the third rod, the upper pin aperture is adjacent to the first aperture of the third rod, the lower pin aperture is adjacent to the second aperture of the third rod, an upper third rod pin is secured to the upper part of the first end of the third rod, and a lower third rod pin is secured to the lower part first end of the third rod, the upper third rod pin is placed within the upper pin aperture and the lower third rod pin is placed within the lower pin aperture, the second end of the third rod defines a third aperture on the upper part of the third rod and a fourth aperture on a lower part of the third rod, the third aperture and the fourth aperture are aligned to each other and adjacent to the second end of the third rod, the third rod is inserted within the second rod; and
a socket mount that has a first end and second end, the first end is hollow and has the same shape as the third rod, yet the socket mount has a greater diameter than the third rod, the second end defines a socket, the first end of the socket mount defines a first socket aperture on an upper part of the socket mount and a second socket aperture on a lower part of the socket mount, the socket mount is mounted on the second end of the third rod and is configured to be secured to the third rod by a pair of socket securing screws.
